(19) United States
(12) Patent Application Publication
(10) Pub. No.: US 2014/0326893 A1
(43) Pub. Date: Nov. 6, 2014

(54) IMAGER OF AN ISOTROPIC LIGHT SOURCE EXHIBITING ENHANCED DETECTION EFFICIENCY

(71) Applicant: COMMISSARIAT A L'ENERGIE ATOMIQUE ET AUX ENE ALT, Paris (FR)

(72) Inventors: Eric Gros D'Aillon, Vourey (FR); Luc Andre, Grenoble (FR); Vincent Reboud, Paris (FR)

(73) Assignee: COMMISSARIAT A L'ENERGIE ATOMIQUE ET AUX ENE ALT, Paris (FR)

(21) Appl. No.: 14/365,279

(22) PCT Filed: Dec. 14, 2012
(86) PCT No.: PCT/EP12/75664

§ 371 Date: Jun. 13, 2014

(30) Foreign Application Priority Data
Dec. 14, 2011 (FR) 11 61645

(51) Int. Cl. G01T 1/20

(52) U.S. Cl. CPC G01T 1/20
USPC 250/366; 250/394; 438/57

(57) ABSTRACT

A radiation imager including: a detector block including at least one detector configured to emit an optical signal from incident radiation to be imaged; a reading block that converts the optical signal into an electrical signal, including a plurality of photodetectors; a plurality of resin portions between the detector block and the photodetectors, in contact with the detector block and in contact with the photodetectors, the resin portions being separated by air, the resin portions including at least a part with cross-section increasing from the detector block to the reading block.

### TECHNICAL FIELD AND PRIOR ART

This invention relates to an imager of an isotropic light source providing enhanced detection efficiency, and particularly radiation imagers, for example ionising radiation imagers.

Ionising radiation imagers are designed to detect ionising radiation, for example X-radiation or gamma radiation. One type of ionising radiation imager uses a scintillator, also called “detector” that converts ionising radiation into visible radiation.

This visible radiation is then detected by photodetectors on the output side of the scintillator in the direction of propagation of the radiation. Photodetectors are usually distributed in matrices.

Photodetectors may be of the CMOS (“Complementary Metal Oxide Semiconductor”) type. Each photodetector comprises an active part that is used to detect light radiation forming the signal, and electronic means. The assembly forms the reading block. Electronic means are assembled in the immediate vicinity of the photodetectors and they are transferred on the sides.

The scintillator is placed on a transparent substrate that forms a mechanical support for the scintillator, this substrate is chosen to be transparent to visible radiation. This assembly is called the detector block and is located above the photodetectors.

The reading block and the detection block are separated by an air gap.

The effect of this air gap is that a large part of visible radiation is trapped in the detector block. Therefore the detection efficiency is very low.

For example, in the case wherein the optical index of the scintillator is equal to 1.82, 92% of visible radiation is trapped in the detector block.

There are also imagers wherein a layer of glue fills in the space between the reading block and the detection block, the quantity of light detected is limited to 39%.

There are also imagers wherein column-shaped structures with constant cross-section extend between the reading block and the detection block. The quantity of collected light is equal to 60%.

There are also radiation imagers wherein column-shaped structures extend between the reading block and the detection block, the section of which reduces from the detection block towards the reading block. These imagers collect light that is slightly inclined from the normal to the plane of the imager.

### PRESENTATION OF THE INVENTION

Consequently, one purpose of this invention is to provide an imager of an isotropic light source providing better detection efficiency than is possible with imagers according to the state of the art.

The previously mentioned purpose is achieved in the case of a radiation imager, the isotropic light source then being formed by a scintillator, by an imager comprising a detector block and a reading block formed by several photodetectors, the photodetectors being arranged at a distance from the detector block, one or several portions made of a first material transparent to visible radiation having a first optical index connecting the detector block to N photodetectors, and a second material with a second optical index less than the first optical index or being a reflecting material, said second material at least partly surrounding one of the portions of a first material, said portion(s) being structured such that its or their cross-section(s) increase monotonically from the detection block towards the photodetector(s) over at least part of their height.

In the case of a CMOS type imager, it comprises a reading block formed from several photodetectors and a glass plate substrate transparent to visible light at a distance from the photodetectors, and several portions made of a first material transparent to visible radiation with a first optical index connecting the detector block to N photodetectors, and a second material with a second optical index less than the first optical index or being a reflecting material, said second material at least partially surrounding one of the portions made of a first material, said portion being structured such that its or their cross-section(s) increase monotonically from the detection block towards the photodetector(s) over at least part of their height.

In other words, light guides tapered outwards towards one or several photodetectors are formed so as to capture visible photons and to carry them to the photodetectors.

These light guides collect light strongly inclined from the normal to the plane of the sensor, said to be high angle light, for example with an angle from the normal to the plane of the sensor exceeding 50°.

The quantity of light at high angles is higher than the quantity at low angles, consequently more light is collected quantitatively than at low angles since light is collected efficiently.

When the second material is reflecting, it reflects part of the light output from said first portion towards this first portion.

With the invention, the quantity of light at high angles collected by the photodetectors is significantly increased.

Preferably, the angle formed between the side edge of portions of the first material and the normal to their base with the smaller area is between [0°; 20°].

Preferably, the second material is air.

In the case of a radiation imager, the detector block comprises a scintillator, preferably comprising a reflecting surface, for example a mirror at the input so as to reflect light generated in the scintillator.

Preferably, the second material separates two adjacent portions.

In other words, it extends between two adjacent portions.

Very advantageously N=1, i.e. each photodetector is optically connected to the detector block through its own light guide.

For example, the first material is composed of an adhesive, for example a glue, also used to fix the detector block and the reading block together. The second material is advantageously air.

The subject-matter of this invention is then a radiation imager that will detect radiation produced by a light source comprising:
a reading block that will convert said radiation into an electrical signal comprising a plurality of photodetectors,
a plurality of portions made of a first material with a first optical index, each portion extending between a lower base and an upper base, the lower base being in contact with the photodetectors,
a second material around the periphery of at least one of said portions, the second material:
having a lower optical index than the first optical index, or

being a reflecting material,

wherein each portion made of a first material extends over a given height between the lower base and the upper base and comprises a zone over at least part of its height with a cross-section increasing from the upper base towards the lower base.

It will be understood that the terms “upper base” and “lower base” do not limit the orientation of the imager and are only used to distinguish the base of the portion made of a first material on the side of the reading block from the other base of the portion made of a first material.

In one embodiment, the imager comprises a transparent substrate, said plurality of portions extending between said substrate and the reading block.

In another embodiment, the imager comprises a detector block, said detector block being capable of producing light radiation, said plurality of portions extending between said detector block and the reading block. Preferably, the detector block comprises a scintillator, a substrate transparent to light, said plurality of portions extending between said substrate and the reading block.

Preferably, the detector block comprises a reflecting surface, for example a mirror, on an inlet face of the scintillator opposite the outlet face.

In one example embodiment, said portions comprise a lateral wall connecting the upper base and the lower base, the tangent to the lateral wall at the upper base forming an angle with the upper base. Preferably, the angle is such that 0<β<60, or even 0<β<20°.

In another example embodiment, each portion made of a first material extends along a given height and has a decreasing or constant cross-section from the upper base towards the lower base over a part of said height, and an increasing cross-section over another part of said height.

The portions made of a first material may have a shape of revolution.

In one variant embodiment, the portions made of a first material are in the form of a truncated paraboloid. In another variant, the portions made of a first material are in the form of a truncated cone.

Preferably, the index of the first material is similar to the index of the detector material, and is preferably between 1.4 and 3. For example, the first material is an adhesive material, particularly a polymer like an SU8 resin or an Epotek353ND, Epotek360ND, Polycarbonate type resin. The second material is preferably a gas, for example air.

In one preferred example, the radiation imager comprises one portion made of a first material for each photodetector, such that each photodetector is individually connected to the detector block through a portion made of a first material. The photodetectors are advantageously in the same plane

Another subject-matter of this invention is a method of making a radiation imager according to this invention comprising the following steps:
preparation of the reading block,
formation of a layer made of a first material on the photodetectors of the reading block, the first material being a resin,
placement of a mould with cavities with the outside shape of said portions above the layer made of a first material,
the cavities are aligned with one or more photodetectors,
the first material is pressed by the mould,
the first material is heated above its glass transition temperature,
the first material is cooled below its glass transition temperature and the mould is then removed,
the detector block and the reading block or the transparent substrate are assembled by means of portions made of a first material.

Another subject-matter of this invention is a method of making a radiation imager according to this invention, comprising the following steps:
preparation of the reading block,
formation of a layer of the first material on the photodetectors of the reading block, the first material being a resin,
insolation of the first material through a mask defining the portions made of a first material,
activation of polymerisation by low temperature annealing,
withdrawal of parts of the first material that were insolated,
assembly of the detector block and the reading block or the transparent substrate through portions made of a first material.

For example, the layer of the first material can be deposited by spin coating.

One or another of the fabrication methods according to the invention may comprise the step to produce the via and connection by means of metal balls.

### BRIEF DESCRIPTION OF THE DRAWINGS

This invention will be better understood after reading the following description and the appended drawings wherein:

FIG. 1 is a side view of an example embodiment of a radiation imager according to this invention,

FIG. 2A is a diagrammatic view of an example embodiment of a portion made of a first material used in the imager in FIG. 1,

FIG. 2B is a diagrammatic view of another example embodiment of a portion made of a first material used in the imager in FIG. 1,

FIG. 3 is a graphic view of the fraction of light collected by a cone of light with a half-angle at the vertex α=56° as a function of the angle of inclination of the wall of a portion made of a first material according to this invention,

FIG. 4 is a graphic view of the fraction of light collected as a function of the angle of incidence for different structures,

FIGS. 5A and 5B are perspective and top views of a matrix of pixels provided with light guides used in the imager in FIG. 1,

FIGS. 6A and 6B are perspective and top views of a pixel in the matrix in FIGS. 5A and 5B,

FIG. 7 is a sectional view of an example embodiment of a CMOS type imager according to this invention;

FIG. 8 is a graphic view of the variation in the percentage of light collected through use a portion made of a first material for a cone of light with a half-angle at the vertex α=56°, as a function of the angle β;

FIGS. 9A and 9B are side views of other example embodiments of portions made of a first material.

### DETAILED DESCRIPTION OF PARTICULAR EMBODIMENTS

The following description will describe details of a radiation imager.

However, this invention also relates to a CMOS type imager capable of imaging visible radiation emitted by a point light source.

The angle of incidence α of the light radiation to be detected is measured relative to a normal to the plane of the imager.

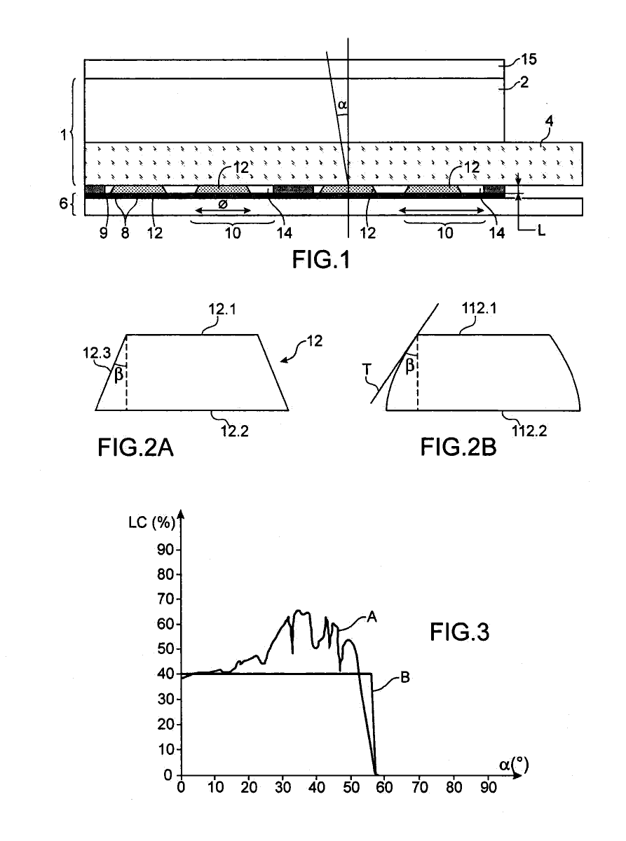

FIG. 1 shows an example of an ionising radiation imager according to this invention shown diagrammatically.

The imager comprises a detector block 1 that in the example shown is composed of a scintillator 2 and a substrate 4 transparent to visible radiation, for example made of glass on which the scintillator 2 is deposited, and a reading block 6 arranged at a distance from the substrate 4 opposite the detector 2. The detector converts ionising photons into visible photons.

The substrate 4 makes the detector rigid, particularly when the reading block 6 is thin. However, this substrate may be omitted if the thickness of the reading block 6 is sufficient to provide its own stiffness. In this case, the scintillator 2 may be considered to act as the substrate 4, because it is a rigid material transparent to the radiation to be detected. Transparent means a material transparent to the wavelengths detected by photodetectors.

The reading block 6 comprises a plurality of photodetectors 8 in the example shown, which are advantageously distributed in a plane. For example, the photodetectors are Avalanche PhotoDiodes, for example SPADs (Single Photon Avalanche Diode), or simple photodiodes.

In our example, the photodetectors 8 are SPAD photodetectors at a distance from each other, each photodetector 8 being delimited by a guard ring 9. Thus, a guard ring 9 delimits the active part of the photodetector 8.

The guard ring 9 confines charges created in the photodiode. The photodetectors 8 are grouped in pixels.

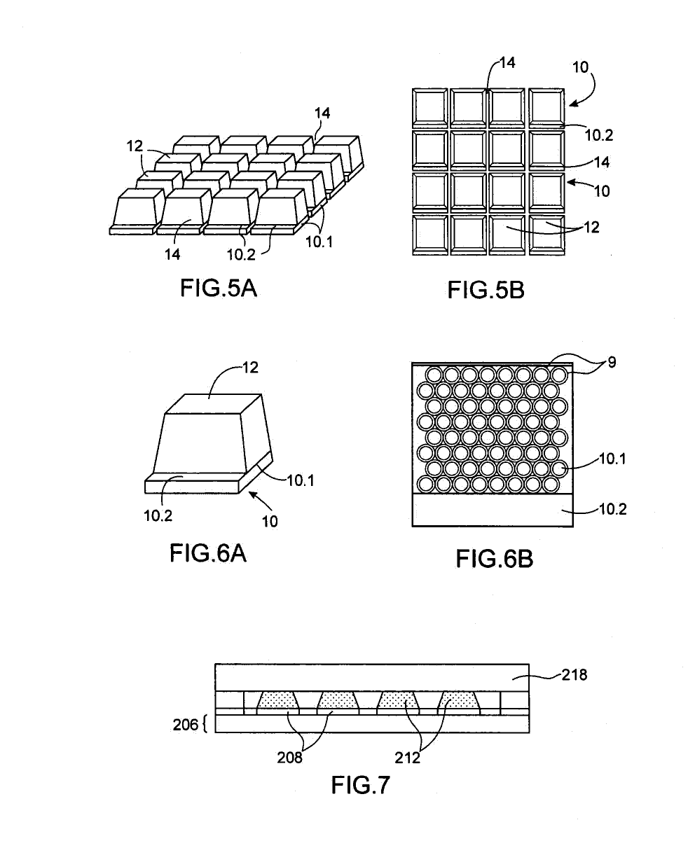

Each pixel has an electronic circuit to process information output from photodetectors 8. The pixels 10 themselves are arranged in a matrix. FIGS. 5A and 5B show a matrix of pixels 10. A single pixel is shown in FIGS. 6A and 6B. The pixel comprises an active part 10.1 that comprises photodetectors 8, that will collect light radiation output from the detector block and an electronic circuit 10.2 arranged on one side of the active part 10.1.

The imager according to the invention also comprises a structure that will optically connect the detector block 1 to the read circuit 6. In other words, this interconnection structure will be inserted:

either between the reading block 6 and the substrate 4,

or between the reading block 6 and the scintillator 2 if there is no substrate 4.

This interconnection structure comprises portions made of a first material 12 placed between the detection block and the reading block, each portion made of a first material 12 optically connecting the substrate 4 and a group of one or several photodetectors.

The portions of the first material 12 are separated from each other by a second material 14, the optical index of which is less than the optical index of the first material. Portions made of a first material 12 are tapered outwards from the detector block towards the reading block. In the example shown, they are in the form of a truncated cone wherein the small base 12.1 is on the side of the detector block and the large base 12.2 is on the side of the reading block. L is the height of portions, Φ the diameter of the large base 12.2 of a portion 12 made of a first material, P is the diameter of the zone containing a photodetector. Thus in general, said portions made of a first material 12 may be arranged:

either between each photodetector 8 and the detector block, which forms the preferred embodiment,

or between a plurality of photodetectors 8 and the detector block 1, this case being shown in FIG. 1. In such a case, a portion made of a first material 12 extends between the detector block and several photodetectors 8, for example the set of photodetectors in the active zone 10.1 of a particular pixel.

FIG. 2A shows a portion made of a first material 12 shown alone, its lateral wall 12.3 forms an angle β relative to the normal to the small base 12.1. β should be considered in the anti-clockwise direction.

β is strictly greater than 0, where 0°<β<90°, but more usually 0°<β<60°, and preferably 0°<β<20°. If the reading block is composed of silicon photodiodes, for example SPADs as mentioned above, it will be preferred that 0°<β<20°. The optimum angle β is defined for each case individually, particularly by simulation of optical paths.

In another example embodiment shown in FIG. 2B, the portions made of a first material 112 are in the form of a paraboloid with a truncated bottom, the bottom with the smaller surface being on the side of the detection block. Each portion made of a first material covers one or several photodetectors.

In this case, the tangent T to the lateral edge 112.3 forms an angle with the small base 112.1. In the case of truncated portions, the tangent T is coincident with the side edge.

Any other shape with a cross-section increasing over all or part of its height from the upper base to the lower base on the side of the photodetector (in other words towards the photodetector) lies within the scope of this invention, for example a portion made of a first material formed by the part of a hyperboloid with an increasing cross-section is within the scope of this invention. Similarly, the cross-section may be constant or even decreasing over the part of the height, and then increasing over another part of said height, the terms increasing and decreasing being understood in the direction from the upper base towards the lower base. In particular, said portions may have a decreasing or constant section between their upper base that will be adjacent to the detector block over a given height, and then an increasing section between said height and their lower base, wherein the lower base will be adjacent to the read circuit. Such a geometry increases the collection efficiency of photons incident to the photodetector at a low angle of incidence, typically less than 20°.

As a variant, the pads may have an increasing section and then a constant section. The effect is practically the same as that obtained with portions with an increasing section. The advantage of this shape is that the height of pads can be adjusted to the geometry of the system in the case wherein the height between the reading block and the detection block is fixed.

Thus in general, each portion or pad made of a first material 12 extends between an upper base that will be placed adjacent to the detector block and a lower base that will be placed adjacent to the read circuit, and has an increasing cross-section over all or part of the height separating said bases. The perimeter of a cross-section of a portion may be circular, elliptical or polygonal.

The cross-section corresponds to the intersection between the portion and a plane parallel to the plane of the imager.

FIGS. 9A and 9B show examples of such portions seen in a side view.

In FIG. 9A, the portion 312 has a part 312.1 with a constant cross-section in contact with the substrate 4 and a part 312.2 with an increasing cross-section from the part 312.1 towards the photodetectors.

In FIG. 9B, the portion 412 has a part 412.1 with a constant cross-section in contact with the substrate 4 with cross-section decreasing from the substrate 4 towards the photodetectors and a part 412.2 with cross-section increasing from part 412.1 towards the photodetectors.

In the example shown, each of the portions 12 made of a first material covers a pixel, the base with the larger area 12.2 is in contact with the active part 10.1 of the pixel leaving the electronic part 10.2 exposed, and the face of the smaller area 12.1 parallel to the face 12.1 is in contact with the substrate 4.

FIG. 6B transparently shows the network of photodetectors 8 with guard rings 9, this network forming the active part.

Preferably, the lower surface of the pad (in the view shown in FIG. 1), in other words the surface that will be put into contact with the photodetector, corresponds to the active surface of the photodetector, or is inscribed in it.

Portions of material covering several photodetectors have the advantage that they improve the mechanical strength of the structure.

The spatial resolution of the imager improves as the number of photodetectors per portion made of a first material reduces, until there is a single photodetector per portion made of a first material. The collection zone of visible photons produced in the detector from ionising photons becomes closer to the zone wherein these visible photons are generated along a direction perpendicular to the stack of the detection block, as the section of portions made of a first material that form light guides becomes closer to the surface of a photodetector.

In this example, a pixel comprises 64 photodetectors, 64 portions made of a first material in the form of a column can then advantageously be formed.

An imager wherein some photodetectors are not covered by a portion made of a first material is within the scope of this invention.

Advantageously, the scintillator comprises a reflecting surface 15 such as a mirror on its upper face, reflecting light radiation generated in the scintillator.

The first material has an optical index close to the optical index of the material of the substrate 4 or the scintillator 2 when the scintillator is adjacent to the interconnection structure. Preferably, the optical index of the first material is between 1.4 and 3.

Advantageously, this first material is an adhesive material, for example a resin used in microelectronic processes. As we will see later, the use of resins is particularly advantageous for making these light guides because it is currently used in microelectronic processes, but for other purposes.

FIG. 3 shows a graphic view of the percentage of collected light LC as a function of the angle of incidence a for an imager comprising portions made of a first material according to the invention (curve A) and by an imager for which the space between the transparent substrate and the reading block is full of resin (curve B).

The height L of the imager used is equal to 2 μm, it has a diameter φ=10 μm, a diameter P=14 μm and an angle β=10°. The portions are surrounded by air.

The scintillator comprises a mirror on its upper face opposite the face facing the reading block.

It is seen that the fraction of light collected by the imager according to the invention (curve A) is higher than the fraction of light collected by an imager comprising a resin layer (curve B) for a between about 15° and about 54°.

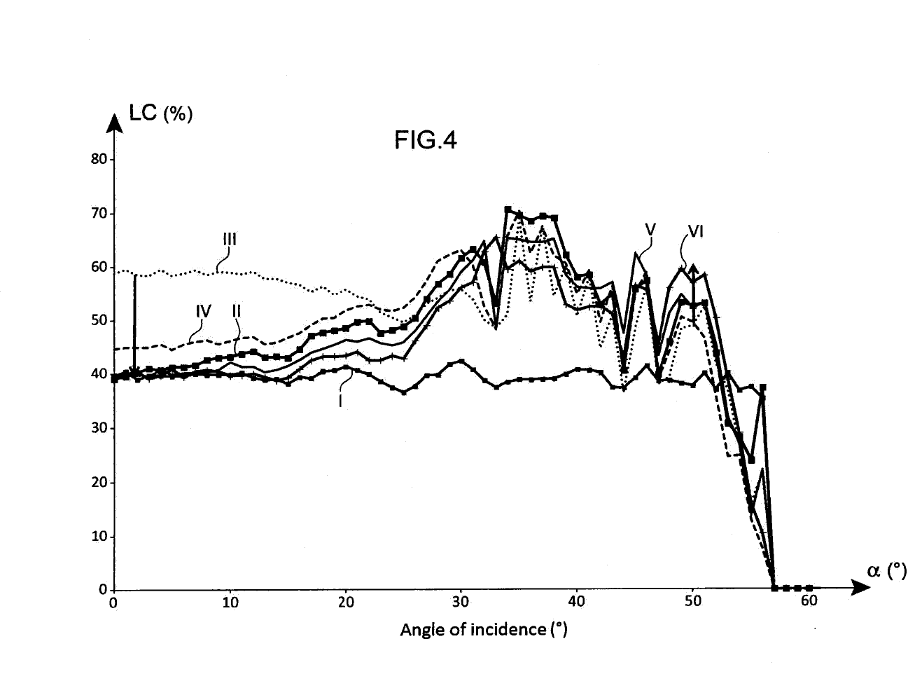

FIG. 4 shows a graphic view of the percentage of collected light (LC) as a function of the angle of incidence for different structures.

The imager comprises a matrix of silicon photodetectors distributed at a period of 19 μm, with a filling ratio of 40%. The area of the matrix is 10×10 mm². The diameter of each photodetector is about 13 μm.

Curve I applies to an imager wherein the zone between the glass substrate and the reading block is full of resin.

Curve II applies to an imager wherein the zone between the glass substrate and the reading block comprises portions with a cylindrical shape and a constant cross-section.

Curves III and IV apply to imagers wherein the zone between the glass substrate and the reading block comprise portions for which the angle β is equal to −30° and −10° respectively, i.e. the portions become continuously smaller from the detector block to the reading block.

Curves V and VI apply to imagers according to the invention wherein the zone between the glass substrate and the reading block comprise portions for which the angle β is equal to 10° and 20° respectively, for example the portions being as shown in FIG. 1.

Curves I and V apply to curves A and B in FIG. 3.

We can see that the portions have a positive angle β (10° (curve V) and 20° (curve VI)), i.e. tapering outwards from the detector block to the reading block, to increase the collection efficiency for large angles between about 50° and 55°.

Consequently for a given interaction in the scintillator material, the number of collected photons is increased. Therefore, the invention can increase the performances of the device in terms of energy resolution. The energy resolution improves with increasing efficiency of collection of radiation with a high angle of incidence α. This is due to the fact that in the case of an isotropic light source, the quantity of photons emerging from the detector block at a high angle of incidence (for example α>25°) is greater than the quantity of photons emerging from the detector at a low angle of incidence. Although photons emerging from the detector at a low angle of incidence (for example <5°) can localise the light source, namely the interaction in the scintillator, photons emerging at a high angle of incidence are used to determine the energy of said interaction. This determination is more precise when the number of detected photons is large.

It can be seen that the collection efficiency at low angles is better for portions with an angle β<0 (curves III and IV). However, at these angles, the quantity of photons detected is smaller than at higher angles because this quantity increases with the area of an arc of a circle with radius da, where α is the angle of incidence.

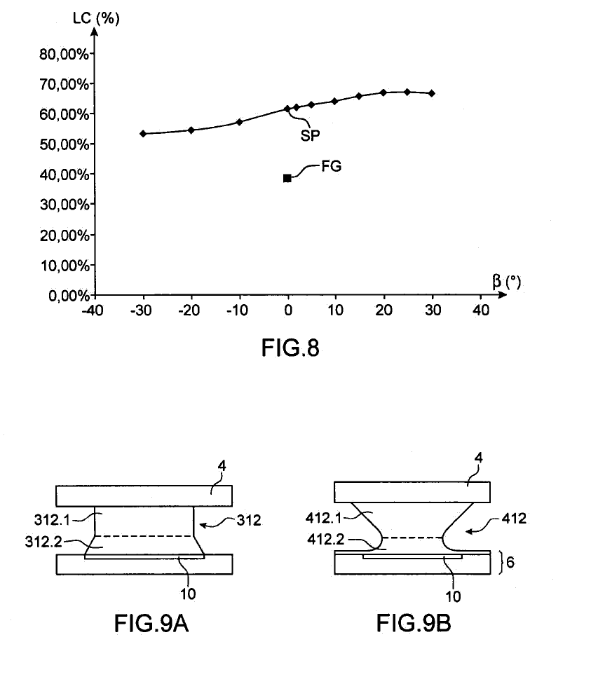

FIG. 8 shows the variation of the percentage of collected light (LC) by the use of a portion made of a first material for a light cone with a half-angle at the vertex α=56°, as a function of the angle β.

It can be seen that the collection efficiency of portions made of a first material with angle β>0 is better for an angle of 56°, and the fraction of light collected increases with the value of the angle β.

The point denoted FG corresponds to the quantity of light collected by an imager with a layer of resin between the reading block and the detector block, in a cone of light with a half-angle a at the vertex equal to 56°. It is equal to 39%.

The quantity of light at the point denoted SP that corresponds to the structure for an angle β=0°, i.e. cylindrical shaped portions with a circular cross-section, is equal to 60%. The quantity of light collected according to the invention, for which points are located to the right of point SP (β>0), is increased and may be equal to 67% for an angle β=20°.

The following table contains values of detectivity, calculated from the following formula

$$μ = {\int }_{0}^{α} η ( α ) sin ( α ) d α$$

$$Wherein$$

$$η ( α ) = \frac{ϕ - L \cdot tan ( β ) + L \cdot tan ( β )}{p}$$

The detectivity μ% is calculated assuming that all light produced in a half-space is collected (α=90°) and μ(45°) corresponds to the light collected directly in a cone with half-angle at the vertex α=45°.

| | | | Conical portions | | | |
|---|---|---|---|---|---|---|
| | | | according to the | | | |
| | Resin layer (FG) | | invention (TC) | | | |
| FF | μ % | μ(45°) | μ % | μ(45°) | (TC-FG)/FG | |
| 40% | 17 | 11 | 22 | 16 | +29 | +45 |
| 62% | 28 | 18 | 34 | 23 | +21 | +28 |

FF is the filling fraction. The filling fraction is the ratio between the surface of the detector block comprising photodetectors and the entire surface of the detector block.

The ratio (TC-FG)/FG shows the gain obtained using the invention relative to an imager comprising a resin layer. Therefore, the invention not only increases the collected light by 21%, it also increases by 28% the quantity of light collected directly in a cone with a half-angle at the vertex equal to 45°.

The imager according to the invention is particularly useful for large angles.

The height of the pads, in other words the distance between their upper base and their lower base, can vary for example between 1 μm and 100 μm, preferably between 5 μm and 30 μm.

If each portion is coupled to a single photodetector, the area of the lower base of each pad is preferably approximately equal to the area of the active part of a photodetector.

The portions may be delimited by a second reflecting material, for example made of a metal, with a lower index than the index of the material used for the pads, such that part of the photons emerging outside a pad are returned into this pad. “Reflecting” means a material for which most of incident light is reflected rather than being absorbed or transmitted.

In a structure wherein the first material of the pads is SiO₂ and the second material is copper or another metal, the photons are reflected: light is guided by reflection, due to the presence of metal and therefore the reflecting material at the interface between the first material and the second material. Metals and for example copper are good reflectors when radiation is in the visible range.

As described above, the portions made of a first material may be deposited either on photodetectors only, for example patterns from a few microns to a few hundred microns depending on the size of the photodetector, or on a set of photodetectors to mask part of the electronics adjacent to these photodiodes, routing etc., the patterns can then be from a few hundred μm to a few mm.

It will be understood that this invention is applicable to other types of imagers than ionising radiation imagers, for example infrared, UV imagers or wavelength shifters.

For example, the first material may be an SU8 resin or an EPO-TEK®353ND, EPO-TEK®360ND type resin, Polycarbonate, SiO₂, etc.

If the second material is a reflecting material, a metal can be chosen, for example copper with index n=0.95, or aluminium.

FIG. 7 diagrammatically shows an example embodiment of a CMOS type imager.

This imager comprises a reading block 206 comprising photodetectors 208 and a substrate transparent to visible light, for example a glass plate 218 fixed to the reading block above the photodetectors and at a distance from it. Portions made of a first material 212 are formed between the glass substrate and the photodetectors and in contact with them, the cross-section made of portions made of a first material 212 increasing from the glass plate to the photodetectors. In the example shown, the portions made of a first material 212 are in the form of a truncated cone, and they may also be in the form of a truncated paraboloid or part of a hyperboloid, or any other shape with an increasing cross-section.

We will now describe examples of a process for making of a radiation imager according to this invention by imprinting. This process is also applicable to the production of CMOS sensors.

The reading block is made that is formed from a substrate comprising matrices of photodetector pixels, without the electrical connections that will be made later by vias.

A layer of photosensitive resin is made on the reading block by spin coating.

In a next step, the mould is aligned with photodetectors and the resin is then imprinted using the mould, the mould comprising a plurality of truncated cone shaped recesses corresponding to the shape of the portions made of a first material 12 using the imprint process. The large base of the truncated cone is in contact with the read module 4. A step to increase the temperature above the glass transition temperature of the first material is then made the mould cavities have been filled with the first material under pressure, it is then cooled to below the glass transition temperature, this cooling being done under pressure, the mould being applied in contact with the photodetectors.

In a next step, the glass substrate or the scintillator is glued directly onto the truncated cone portions. The resin portions 12 are then in contact with the glass substrate 2 and the photodetectors 8.

If the reading block comprises a glass substrate, there is a thinning step of the substrate of the reading block that may for example be made of silicon, for example by polishing. The mechanical strength of the assembly is provided mainly by the glass substrate 4.

The electrical connections from the reading block are then made using vertical connections or vias (TSV “Through-silicon Via) through the substrate and connection balls.

The scintillator and the reading block are assembled if the scintillator is not already assembled on the reading block.

The use of a mould enables the production of portions of resin with a truncated lentil shape, or a truncated cone or a truncated paraboloid with an angle β that may be relatively large.

When the first material forming the pads is not sufficiently adhesive, a third material with a refraction index preferably less than the refraction index of the first material can be used. This third material is adhesive, such that it enables good adhesion between the pads and the detection module.

Portions made of a first material may also be made by photolithography, preferably in the case wherein β is small, in other words when β<20°. To achieve this, a matrix of photodetectors may for example be coated with a photosensitive resin, for example resin JR 335. Doses and focusing distances can then be controlled to obtain different types of structures with a low slope.

The scintillator block is assembled on the waveguides after the development of non-exposed zones.

The dose is of the order of 300 mJ/cm² and defocalisation can vary from −10 μm to 10 μm.

This process for example comprises steps to:
form a resin layer on the photodetectors or on the glass substrate, for example a 3 μm layer of JR 355,
form a mask on the resin layer,
UV insolation of the resin through a mask, defining resin portions in the resin,
development of insolated zones, by doing low temperature annealing to activate polymerisation, a chemical etching is then made to remove parts of the resin that have been insolated. One resin frequently used for this purpose is JSR M78Y with a thickness of between 500 nm and 1 μm deposited by spin coating. The resin is then annealed a first time at 130° C. in order to eliminate solvents. After insolation, the resin is heated to the same temperature for a second time, to be set. The developer used is TMAH (Tetramethylammonium hydroxide).

In the embodiment presented above, an interconnection structure is described with pads 12 that will be placed between a transparent substrate (substrate 4 or scintillator 2) and a read circuit comprising photodetectors. In this embodiment, the light source corresponds to interaction of ionising radiation (for example X, γ, α or β) in a scintillator material, this interaction possibly being treated as an isotropic light source.

The invention can be applied to detection of radiation produced by another light source, particularly an isotropic source, in a transparent medium other than a scintillator when it is required to increase the efficiency of collecting photons.

1-19. (canceled)

20. A radiation imager that will detect radiation produced by a light source, comprising:
a reading block that will convert the radiation into an electrical signal, comprising a plurality of photodetectors;
a plurality of portions made of a first material with a first optical index, each portion extending between a lower base and an upper base, the lower base being in contact with the photodetectors;
a second material around a periphery of at least one of the portions, the second material:
having a lower optical index than the first optical index, or being a reflecting material;
wherein each portion made of a first material extends over a given height between a lower base and an upper base and comprises a zone over at least part of its height with a cross-section increasing from the upper base towards the lower base.

21. The radiation imager according to claim 20, further comprising a transparent substrate, the plurality of portions extending between the substrate and the reading block.

22. The radiation imager according to claim 20, further comprising a detector block, the detector block configured to produce light radiation, the plurality of portions extending between the detector block and the reading block.

23. The radiation imager according to claim 22, wherein the detector block comprises a scintillator, a substrate transparent to light, the plurality of portions extending between the substrate and the reading block.

24. The radiation imager according to claim 23, wherein the detector block comprises a reflecting surface, or a mirror, on an inlet face of the scintillator opposite an outlet face.

25. The radiation imager according to claim 20, wherein the portions comprise a lateral wall connecting the upper base and the lower base, the tangent to the lateral wall at the upper base forming an angle β with the upper base such that 0<β<60°, or 0<β<20°.

26. The radiation imager according to claim 20, wherein each portion made of a first material extends along a given height and has a decreasing or constant cross-section from the upper base towards the lower base over a part of the height, and an increasing cross-section over another part of the height.

27. The radiation imager according to claim 20, wherein the portions made of a first material have a shape of revolution.

28. The radiation imager according to claim 20, wherein the portions made of a first material are in a form of a truncated paraboloid.

29. The radiation imager according to claim 20, wherein the portions made of a first material are in a form of a truncated cone.

30. The radiation imager according to claim 20, wherein an index of the first material is similar to an index of the detector material, or is between 1.4 and 3.

31. The radiation imager according to claim 20, wherein the first material is an adhesive material, or a polymer of an SU8 resin or an Epotek353ND, Epotek360ND, Polycarbonate type resin.

32. The radiation imager according to claim 20, wherein the second material is a gas, or is air.

33. The radiation imager according to claim 20, comprising one portion made of a first material for each photodetector such that each photodetector is individually connected to the detector block through a portion made of a first material.

34. The radiation imager according to claim 20, wherein the photodetectors are in a same plane.

35. A method of making a radiation imager according to claim 20, comprising:
preparing the reading block;
forming a layer made of a first material on the photodetectors of the reading block, the first material being a resin;
placing a mold with cavities with an outside shape of the portions above the layer made of a first material;
aligning the cavities with one or more photodetectors;
pressing the first material by the mold;
heating the first material above its glass transition temperature;
cooling the first material below its glass transition temperature and then removing the mold;
assembling the detector block and the reading block or the transparent substrate by portions made of a first material.

36. A method of making a radiation imager according to claim 20, comprising:
preparing the reading block;
forming a layer of the first material on the photodetectors of the reading block, the first material being a resin;
insolating the first material through a mask defining the portions made of a first material;
activating polymerization by low temperature annealing;
withdrawing parts of the first material that were insolated;
assembling the detector block and the reading block or the transparent substrate through portions made of a first material.

37. The method according to claim 35, wherein the layer of the first material is deposited by spin coating.

38. The method according to claim 35, further comprising producing a via and connection by metal balls.

39. The method according to claim 36, wherein the layer of the first material is deposited by spin coating.

40. The method according to claim 36, further comprising producing a via and connection by metal balls.
